(19) United States
(12) Patent Application Publication
(10) Pub. No.: US 2008/0277485 A1
(43) Pub. Date: Nov. 13, 2008

(54) MEMORY CARD HAVING MULTIPLE APPLICATION-BASED FUNCTIONS, METHOD OF MANUFACTURING THE SAME, METHOD OF OPERATING THE SAME AND DIGITAL DEVICE APPLYING THE SAME

(75) Inventor: Jin-Jun Park, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/119,996

(22) Filed: May 13, 2008

Related U.S. Application Data
(63) Continuation-in-part of application No. 11/745,121, filed on May 7, 2007.

(30) Foreign Application Priority Data
May 17, 2007 (KR) 2007-47943

(51) Int. Cl. G06K 19/06; G06K 19/00

(52) U.S. Cl. 235/492; 235/487

(57) ABSTRACT

A memory card includes a printed circuit board (PCB) defining an interior space. A control chip is in the interior space. A memory chip is electrically coupled to the control chip. A contact pad is on the PCB outside the interior space. A converting member is located outside the interior space. The converting member is configured to provide an indication to the control chip to change an application function of the control chip and an interface function of the contact pad based on an external input to the memory card. A multi-interface member is located completely inside the interior space of the PCB and electrically coupled to the control chip and the converting member to change the application function of the control chip and the interface function of the contact pad based on operations of the converting member.

### CROSS-REFERENCE TO RELATED APPLICATIONS

This application is a continuation-in-part of U.S. patent application Ser. No. 11/745,121, filed on May 7, 2007. This application also claims priority under 35 U.S.C. § 119 to Korean Patent Application No. 2007-47943, filed on May 17, 2007, in the Korean Intellectual Property Office (KIPO), the contents of which are incorporated herein by reference in their entirety.

### FIELD OF THE INVENTION

The present invention relates to the field of electronics, and more particularly, to memory cards for digital devices.

### BACKGROUND

Recently, digital devices such as computers, cellular phones, digital cameras, camcorders, etc., have been rapidly developed. Therefore, a memory card as a storage medium, which is used for a peripheral device of a digital device, has also been quickly improved. Particularly, a memory card can have gigabytes of storage capacity. Examples of a conventional memory card are disclosed in Korean Patent Laid-Open Publication Nos. 2006-81703 and 2006-64291.

However, the size, the number of contact pads, etc., of the memory card may vary in accordance with the kind of digital device such as a computer, a cellular phone, a digital camera, a camcorder, etc. That is, a memory card applicable for a computer, a memory card applicable for a cellular phone, a memory card applicable for a digital camera and a memory card applicable for a camcorder may have different sizes and different numbers of the contact pads.

Since conventional memory cards may not be compatible with the digital device, separate memory cards may be needed for each type of digital device.

### SUMMARY

A memory card in accordance with one aspect of the present invention can include a memory card including a box-shaped printed circuit board (PCB) defining at least a partially enclosed interior space. A control chip is in the interior space defined by the box-shaped PCB, where the control chip may be selectively configured according to one or more application functions. A memory chip is in the interior space and is electrically coupled to the control chip, the memory chip being configured to store data. A contact pad is on the box-shaped PCB outside the interior space, where the contact pad is electrically coupled to the control chip. A converting member is located outside the interior space that is defined by the box-shaped PCB and is electrically coupled to the control chip. The converting member is configured to provide an indication to the control chip to change the application function of the control chip and an interface function of the contact pad based on an external input to the memory card. A multi-interface member is located completely inside the interior space of the PCB and electrically coupled to the control chip and the converting member to change the application function of the control chip and the interface function of the contact pad based on operations of the converting member.

Therefore, the functions of the control chip and an interface function of the contact pad may be converted to be suitable for different digital devices by operating the converting member.

### BRIEF DESCRIPTION OF THE DRAWINGS

FIG. 1 is a plan view illustrating a memory card in accordance with some example embodiments of the present invention;

FIG. 2 is a cross-sectional view illustrating the memory card in FIG. 1;

FIGS. 3 to 7 are plan views and perspective views illustrating a method of operating the memory card in FIGS. 1 and 2;

FIG. 8 is a cross-sectional view illustrating the method of manually operating the memory card in FIG. 6;

FIG. 9 is a flowchart illustrating the method of electrically operating the memory card in FIG. 7;

FIGS. 10 and 11 are perspective views illustrating digital devices to which the memory card in FIG. 1 is applied;

FIGS. 12A to 12D are cross-sectional views illustrating a method of manufacturing the memory card in FIGS. 1 and 2 in accordance with some example embodiments of the present invention; and

FIGS. 13A to 13C are cross-sectional views illustrating a method of manufacturing the memory card in FIGS. 1 and 2 in accordance with some example embodiment of the present invention.

### DESCRIPTION OF EMBODIMENTS ACCORDING TO THE INVENTION

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

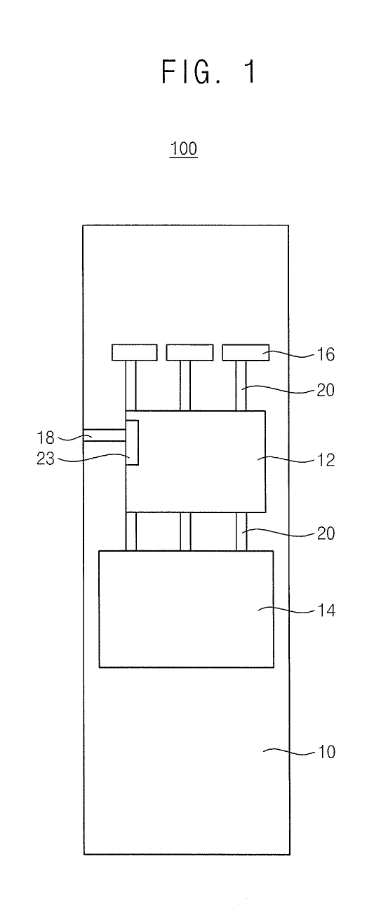

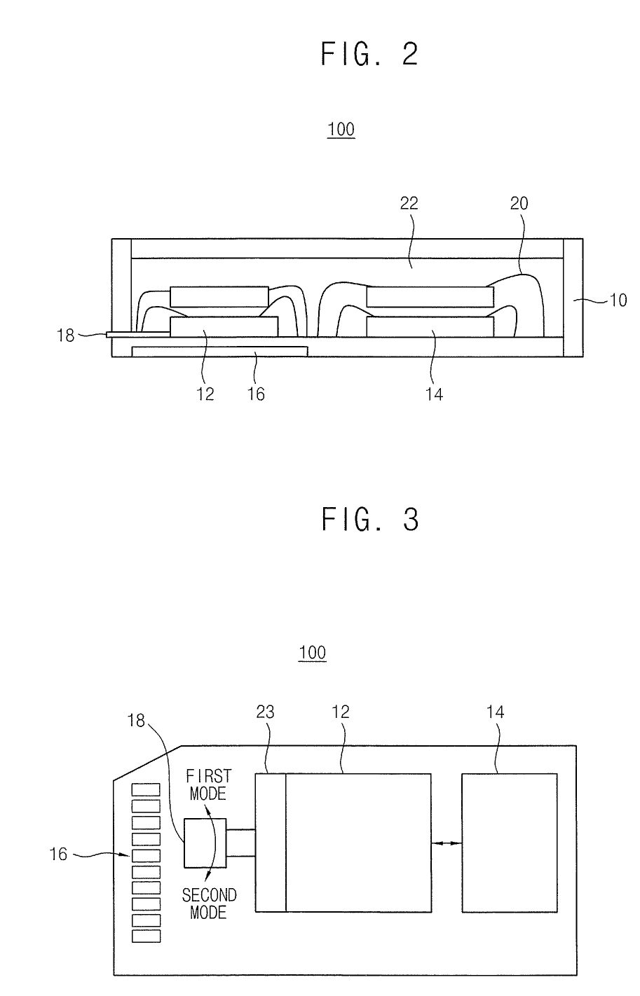

FIG. 1 is a plan view illustrating a memory card in accordance with a first example embodiment of the present invention, FIG. 2 is a cross-sectional view illustrating the memory card in FIG. 1, and FIGS. 3 to 5 are plan views illustrating applications of the memory card in FIGS. 1 and 2.

Referring to FIGS. 1 and 2, a memory card 100 in accordance with this example embodiment includes a printed circuit board (PCB) 10. Particularly, the PCB 10 is bent into a box shape to obtain the memory card 100.

It will be understood that, as used herein, the term “box” means that the PCB is formed to define an interior space in which the components mounted on the present PCB are enclosed. Moreover, some portions of the box shape may be open. For example, the box shape of the PCB may define the interior space so that the chips mounted thereon are completely enclosed. Alternatively, the box shape may be open, such as, at the ends. Accordingly, the term box is not limited to configurations that completely enclosed the interior space in which the components are mounted on the PCB.

A chip module is formed in the box-shaped PCB 10 that is obtained by the bending process. The chip module includes a control chip 12 having convertible functions and a memory chip 14 for storing data. Here, an example of the control chip 12 may include a microprocessor. Further, an example of the memory chip 14 may include a flash memory. Contact pads 16 are formed on the box-shaped memory card 100. The contact pads 16 are electrically connected to the chip module. Further, the memory card 100 includes a converting member 18 connected to the control chip 12. The converting member 18 converts the functions of the control chip 12 by an operation from outside of the PCB 10 and an interface function of the contact pads 16. The control chip 12 and the memory chip 14 are electrically connected to each other via a wire 20. Further, the wire 20 is connected between the control chip 12 and the memory chip 14 and, at the same time, the wire 20 is connected to the contact pads 16 on the box-shaped PCB 10. A molding member 22 is formed on the box-shaped PCB 10 to support the control chip 12, the memory chip 14 and the wire 20.

Additionally, a multi-interface member 23 is arranged in the interior space of the PCB 10 and electrically coupled to the control chip 12 and the converting member 18 to change the application function of the control chip 12 and the interface function of the contact pad 16 based on operations of the converting member 18. In some embodiments according to the invention, the multi-interface member 23 is located completely inside the interior space of the PCB 10. It will be understood that the multi-interface member 23 can be a circuit that operates responsive to the converting member 18 to re-define the input/output to/from the control chip 12 and the contact pad 16 so that the control chip 12 can operate according to the selected application function. For example, in a first setting the converting member 18 can indicate that the multi-interface member 23 is to provide a first arrangement of inputs (form the contact pads) to the control chip and to provide a first arrangement of the outputs from the control chip 12. Similarly, when converting member 18 is switched to indicate a second application function, the multi-interface member 23 can re-define the inputs/outputs of the control chip 12 to provide the second application function. Accordingly, in some embodiments according to the invention, the control chip may not need to be structurally altered to provide different application functions.

It will be understood that the converting member 18 may be any device which allows an external signal or mechanism to control the function provided by the control chip/interface. For example, the converting member 18 may be a switch, a circuit, a fuse, a jumper, or the like. Furthermore, the converting member may be one-time programmable (such as a laser programmable fuse) or reprogrammable (such as a nonvolatile memory or register). Accordingly, the backend process used during the manufacturing of the memory cards would be adapted to select the desired function for the controller chip/interface based on the nature of the converting member 18. For example, if the converting member 18 is a laser programmable fuse, a backend process used to manufacture the memory card may employ a laser to cut fuses included in the converting member 18.

The control chip 12 controls functions of the PCB 10. In this example embodiment, the number of the control chips 12 may be at least one or two.

When the memory card 100 includes the single control chip 12, the single control chip 12 has various functions. That is, the various functions of the single control chip 12 are compatible with different digital devices. Therefore, when the memory card 100 includes the single control chip 12, the functions of the single control chip 12 are converted to be suitable for the different digital devices by operating the converting member 18 and the multi-interface member 23.

In contrast, when the memory card 100 includes at least the two control chips 12, each of the two control chips 12 can have different functions. That is, each of the functions of the control chips 12 is compatible with different digital devices. In other words, any one of the two control chips 12 can have a function suitable for a first digital device, and the remaining control chip 12 can have a function suitable for a second digital device. Therefore, when the memory card 100 includes the two single control chips 12, each of the functions of the control chips 12 is converted to be suitable for the different digital devices by operating the converting member 18 and the multi-interface member 23.

In this example embodiment, there are illustrated the single control chip 12 or the two control chips 12. In some embodiments according to the invention, the memory card 100 may include at least three control chips based on the above illustrations.

Further, when the memory card 100 includes at least two control chips 12, the control chips 12 may be advantageously stacked. The stacked structure of the control chip 12 may increase an integration degree of the memory card 100.

When the converting member 18 converts the functions of the control chip 12, the interface function of the contact pads 16 may be simultaneously converted. That is, the converting member 18 converts the interface function of the contact pads 16 as well as the functions of the control chip 12. Thus, the functions of the memory card 100 are converted to be suitable for the different digital devices so that the memory card 100 may be readily compatible with the different digital devices.

To increase the storage capacity of the memory chip 14, at least two memory chips 14 may be formed in the PCB 10. When at least two memory chips 14 are formed in the PCB 10, the memory chips 14 may be advantageously stacked, thereby increasing an integration degree of the memory card 100.

In addition, the memory card 100 may further include a driver for driving the memory card 100, an interface member for transmitting a signal, etc.

In operation, the memory card may operate according to a first application function, such as an interface and function according to a digital camera. Upon receiving an external input at the memory card at the converting member, the controller circuit ceases operating according to the first application function and subsequently begins operating according to a second application function, such as an MP3 player. Furthermore, the interface to the memory card may be changed from a configuration that accommodates the first application function to a configuration that supports the second application function. For example, the signals provided to the memory card during the first application function may be interpreted according to the first application whereas the signals provided subsequent to the change may be interpreted according to the second application. Accordingly, the signals received at the same contact during different application functions may be interpreted differently.

That is, the memory card 100 includes the box-shaped PCB 10 having the inner space where the control chip 12 is located, and the converting member 18 connected to the control chip 12 to convert the functions of the control chip 12 based on an external input to the memory card 100. Thus, the functions of the control chip 12 and the interface functions of the memory card 100 may be converted to be compatible with the different digital devices by operating the converting member 18.

FIGS. 3 to 7 are plan views and perspective views illustrating usage examples of the memory card in FIGS. 1 and 2. Here, the same reference numerals refer to the same elements of the memory card 100 in FIGS. 1 and 2.

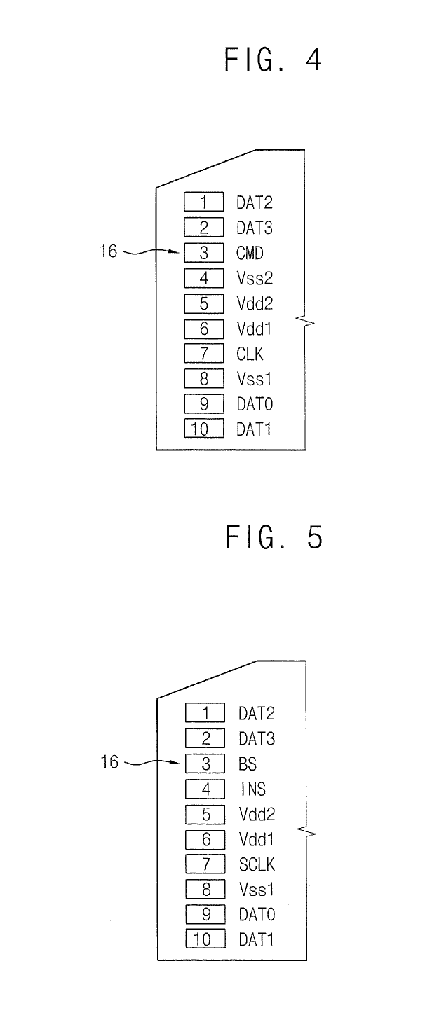

Referring to FIG. 3, the memory card 100 includes a single control chip 12 having a first function and a second function. A multi-interface member 23 is arranged in the interior space of the memory card 100 and electrically coupled to the control chip 12 and the converting member 18 to change the application function of the control chip 12 and the interface function of the contact pad 16 based on operations of the converting member 18. The multi-interface member 23 can be a circuit that operates responsive to the converting member 18 to re-define the input/output to/from the control chip 12 and the contact pad 16 so that the control chip 12 can operate according to the selected application function. When the converting member 18 is provided with a first mode, the control chip 12 has the first function. In contrast, when the converting member 18 is provided with a second mode, the control chip 12 has the second function. Further, when the converting member 18 is provided with a first mode, the interface function of the contact pads 16 is converted into a mode in FIG. 4. In contrast, when the converting member 18 is provided with a second mode, the interface function of the contact pads 16 is converted into a mode in FIG. 5.

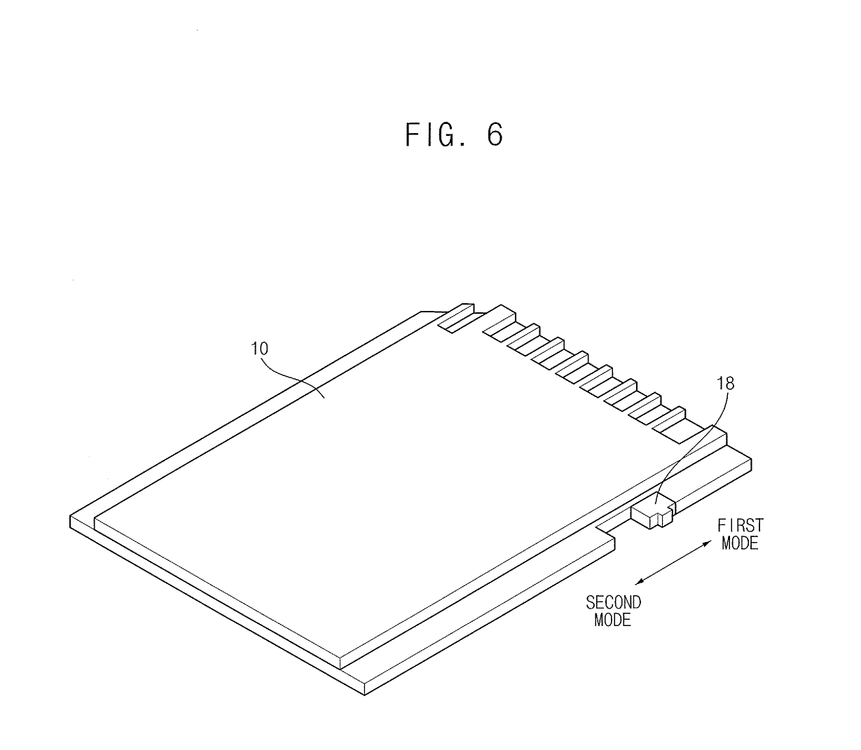

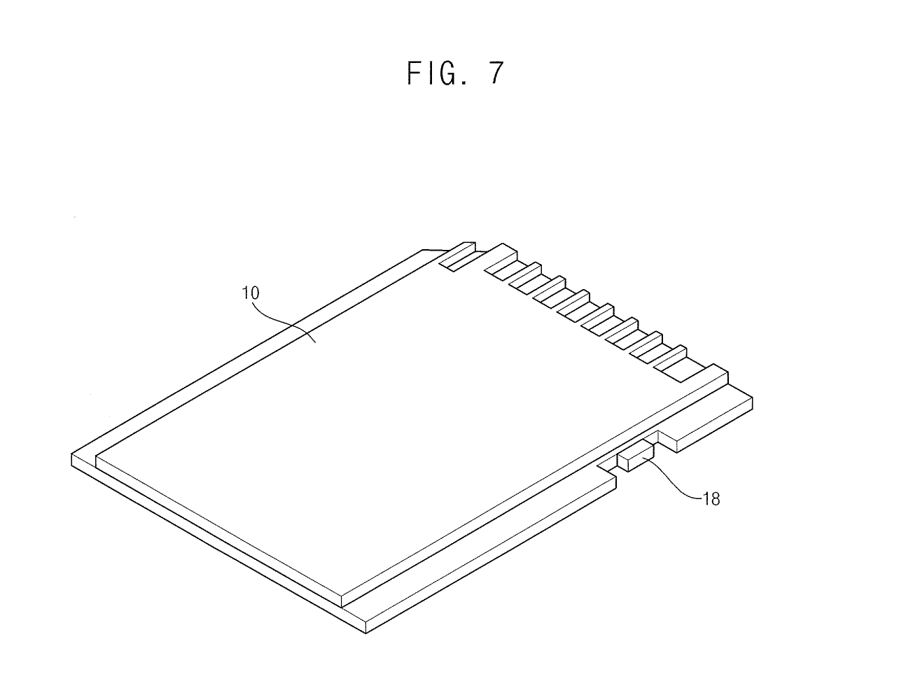

Here, as shown in FIG. 6, the converting member 18 may be provided with the first mode or the second mode by a manual operation. Alternatively, as shown in FIG. 7, the converting member 18 may be provided with the first mode or the second mode by an electrical operation.

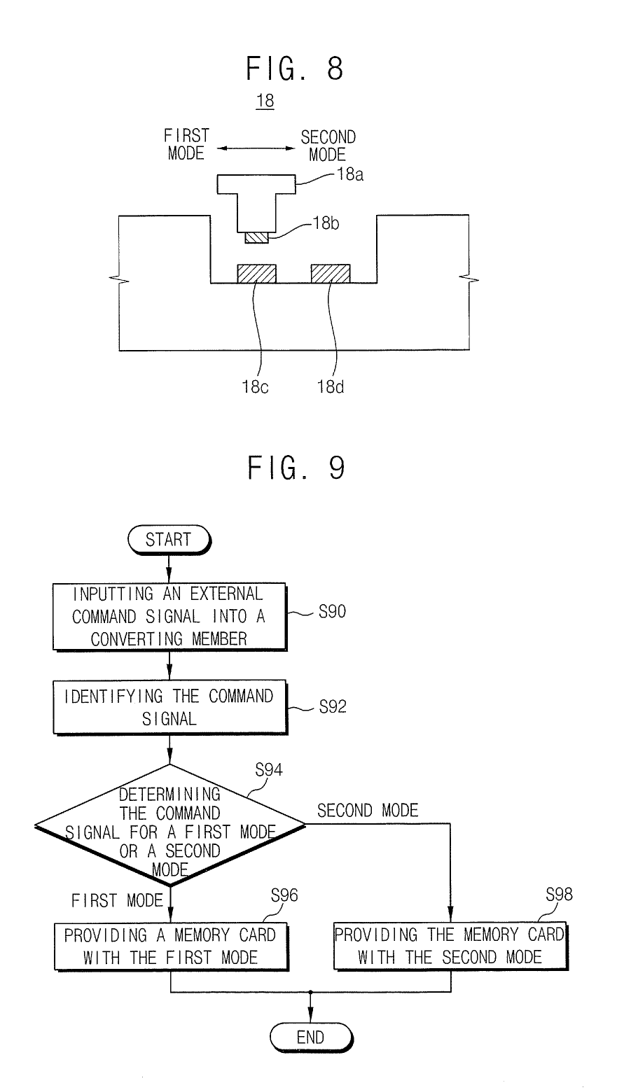

Particularly, as shown in FIG. 8, the converting member 18, which is manually operated to be in the first mode or the second mode, may include a manual switch 18a, a mode selection terminal 18b provided to an end of the switch 18a, and first mode terminal 18c and a second mode terminal 18d selectively making contact with the mode selection terminal 18b. In usage of the memory card 100 having the manually operated converting member 18, when the switch 18a is pressed toward the first mode direction for allowing the mode selection terminal 18b and the first mode terminal 18c to make contact with each other, the memory card 100 is provided with the first mode. In contrast, when the switch 18a is pressed toward a second mode direction for allowing the mode selection terminal 18b and the second mode terminal 18d to make contact with each other, the memory card 100 is provided with the second mode.

Alternatively, as shown in FIG. 7, the converting member 18 may be provided with the first mode or the second mode by an electrical operation. In this example embodiment, when the converting member 18 is electrically operated, the converting member 18 may include a circuit, a fuse, a jumper, etc., operated by an external command.

Particularly, as shown in FIG. 9, in step S90, an external command signal is inputted into the converting member 18s electrically operated to have the first mode or the second mode. Here, the command signal may include an electrical signal. In step S92, the converting member 18 then identifies the command signal. In step S94, the converting member 18 determines the identified command signal for the first mode or the second mode. In step S96, when the command signal is determined as the first mode, the converting member 18 provides the memory card 100 with the first mode. In contrast, in step S98, the command signal is determined as the second mode, the converting member 18 provides the memory card 100 with the second mode.

In this example embodiment, the converting member 18 may include the switch, the circuit, the fuse, the jumper, etc. These can be used alone or in a combination thereof.

Accordingly, in the memory card 100, the functions of the control chip 12 are converted into the first function by adjusting the converting member 18 to have the first mode, and the interface function of the contact pads 16 is also converted to be suitable for the first function of the control chip 12. Further, the functions of the control chip 12 are converted into the second function by adjusting the converting member 18 to have the second mode, and the interface function of the contact pads 16 is also converted to be suitable for the second function of the control chip 12.

For example, when the converting member 18 is provided with the first mode, the functions of the memory card are converted to be suitable for a cellular phone. Further, when the converting member 18 is provided with the second mode, the functions of the memory card are converted to be suitable for a digital camera.

That is, the memory card 100 may be operated in accordance with the first function. Here, an example of the first function may include the first digital device such as a cellular phone. The memory card 100 may be operated in accordance with the first function suitable for the first digital device. Further, the memory card 100 may then be operated in accordance with the second function after operated the memory card 100 having the first function.

An external signal may be inputted into the memory card 100. Here, the external signal may be inputted into the memory card 100 from the converting member 18. The memory card 100 may be operated in accordance with the second function by converting the converting member 18. In this example embodiment, an example of the second function may include a second digital device such as a digital camera. The memory card 100 may be operated in accordance with the second function suitable for the second digital device.

Further, the interface functions of the memory card 100 may be converted based on the external signal, which is received in the memory card 100 through a single contact of the memory card 100, for changing the functions of the memory card 100. As a result, the memory card 100 may be compatible with different digital devices.

Here, in this example embodiment, the memory card 100 including the single control chip 12 that has the first function and the second function is exemplarily illustrated. Alternatively, the memory card 100 may include a single control chip having first to n-th functions or a plurality of control chips having first to n-th functions, respectively.

The memory card 100 of the present invention may be compatible with the different digital devices based on the above-mentioned memory card and the usage examples of the memory card.

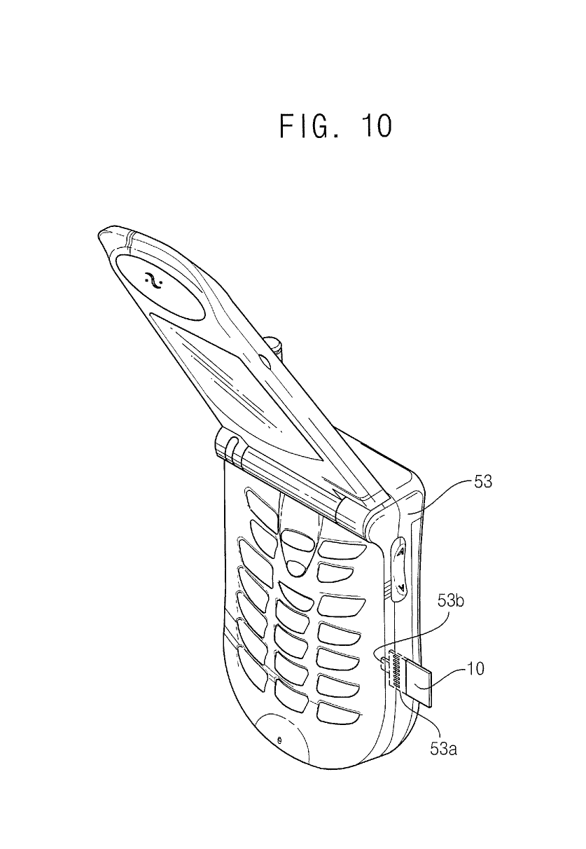

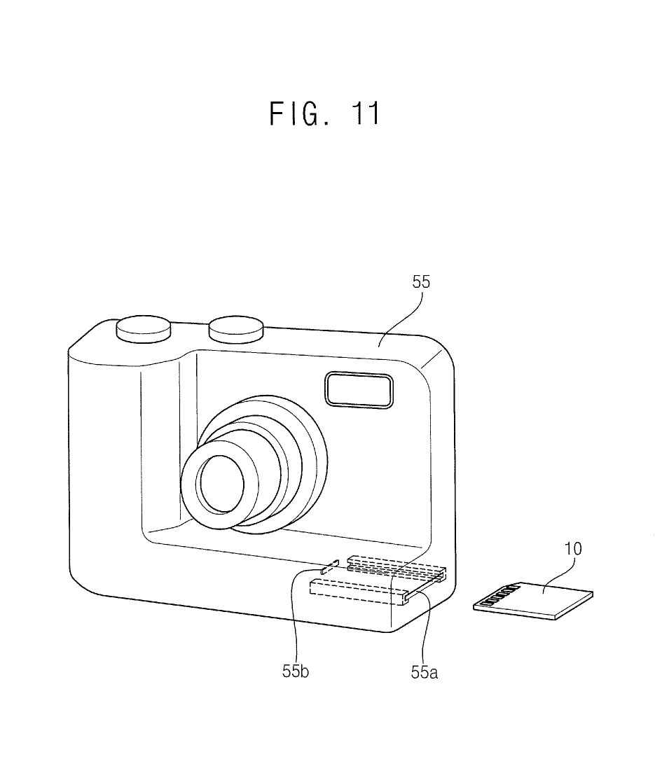

FIGS. 10 and 11 are perspective views illustrating digital devices to which the memory card in FIG. 1 is applied.

Referring to FIG. 10, a single structured memory card 10 having a first mode and a second mode is prepared. That is, the memory card 10 in FIG. 6 or 7 is prepared. A first digital device 53 such as a cellular phone is prepared. Here, the first digital device 53 includes a receiving member 53a for receiving the memory card 10, and an identifying member 53b for identifying selection of the first mode or the second mode with respect to the memory card 10 inserted into the first digital device 53 through the receiving member 53a.

Accordingly, when the memory card 10, which is provided with the first mode having functions suitable for the first digital device 53 such as the cellular phone, is inserted into the first digital device 53, the identifying member 53b identifies the memory card 10 having the first mode. Thus, the memory card 10 may be readily used for the first digital device 53 such as the cellular phone.

Referring to FIG. 11, the memory card 10 substantially the same as that in FIG. 10 is prepared. That is, the single structured memory card 10 is prepared. A second digital device 55 such as a digital camera is prepared. Here, the second digital device 55 includes a receiving member 55a for receiving the memory card 10, and an identifying member 55b for identifying selection of the first mode or the second mode with respect to the memory card 10 inserted into the second digital device 55 through the receiving member 55a.

Accordingly, when the memory card 10, which is provided with the second mode having functions suitable for the second digital device 55 such as the digital camera, is inserted into the second digital device 55, the identifying member 55b identifies the memory card 10 having the second mode. Thus, the memory card 10 may be readily used for the second digital device 55 such as the digital camera.

Here, examples of the digital devices compatible with the memory card may not be restricted within the above-mentioned cellular phone and the digital camera. Further, the memory card may additionally have third to n-th modes as well as the first mode and the second mode. Therefore, the memory card may be compatible with third to n-th digital devices. Here, n is a natural number of no less than 4.

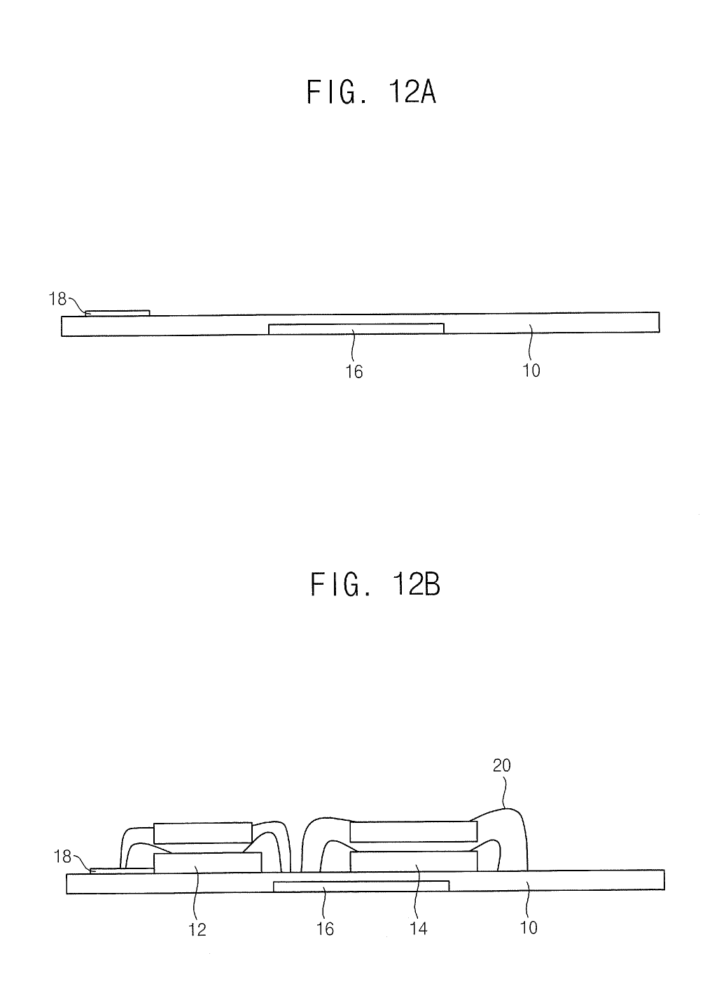

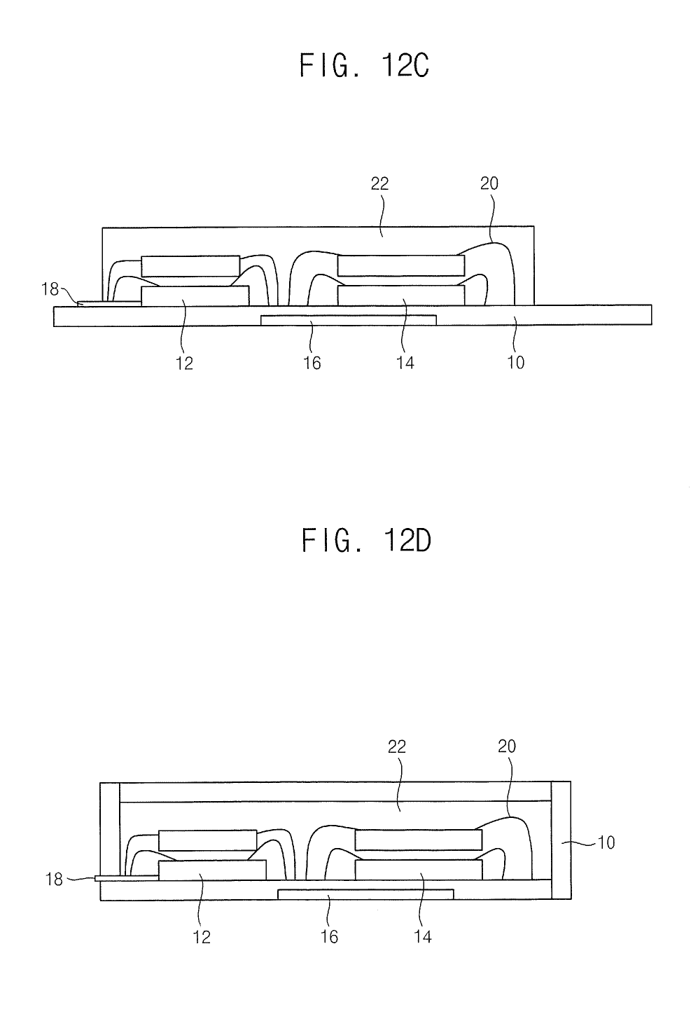

FIGS. 12A to 12D are cross-sectional views illustrating methods of manufacturing the memory card in FIGS. 1 and 2 in some embodiments according to the present invention. Here, the same reference numerals refer to the same elements of the above-mentioned memory card 100.

Referring to FIG. 12A, the PCB 10 is prepared. Here, the contact pad 16 is formed on a first face of the PCB 10. The converting member 18 is formed on the PCB 10. When the PCB 10 is bent into the box shape, the contact pad 16 is positioned on a second face of the box-shaped PCB 10 opposite to the first face. Further, the contact pad 16 may be readily formed in accordance with a design of the PCB 10.

As used herein, the term “bent” includes the application of any force used to provide the shape of the PCB 10 to enclose the components mounted thereon in the box shape described above. For example, in some embodiments according to the invention, the PCB 10 may be molded, deformed, molded, assembled, stamped or any other type of operation known to those skilled in the art used to form a box shape as described herein.

Referring to FIG. 12B, the chip module is formed on the second face of the PCB 10. That is, the control chip 12 having convertible functions and the memory chip 14 for storing data are formed on the second face of the PCB 10. Further, when the control chip 12 and the memory chip 14 have at least two, respectively, the control chips 12 and the memory chips 14 may be stacked according to an integration degree of the memory card 100.

The control chip 12 and the memory chip 14 are then electrically connected to each other using a wire 20. Further, the wire 20 is electrically connected to the contact pad 16. The converting member 18 is electrically connected to the control chip 12. Here, when the PCB 10 is bent into the box shape, the converting member is located at an outside of the PCB for allowing the converting member 18 to be handled by the outside operation.

Referring to FIG. 12C, after the control chip 12, the memory chip 14 and the wire 20 are formed, the molding member 22 covers the control chip 12, the memory chip 14 and the wire 20 to firmly fix the control chip 12, the memory chip 14 and the wire 20.

Here, when forming the molding member 22, the converting member 18 is not firmly fixed by the molding member 22 to provide the converting member 18 with the external input operation. Thus, the formation of the molding member 22 allows the converting member 18 to be operated based on the external input.

Referring to FIG. 12D, the PCB 10 is bent into the box shape, thereby completing the memory card 100, which includes the contact pad 16 on the box-shaped PCB 10 and the chip module in the box-shaped PCB 10.

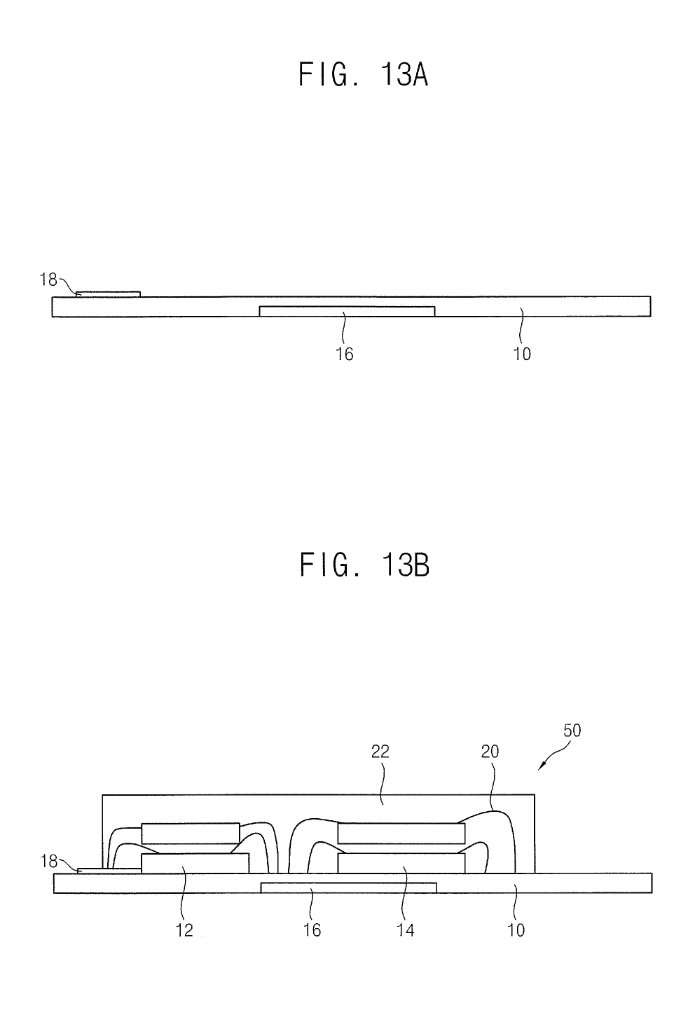

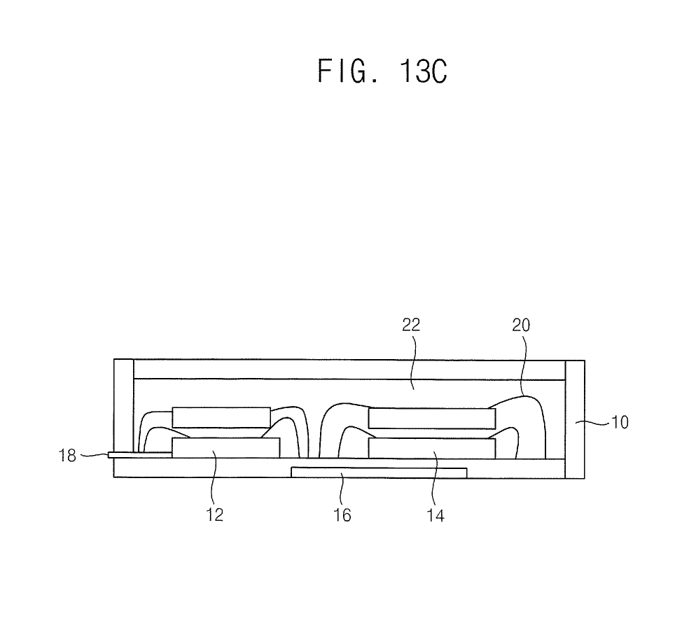

FIGS. 13A to 13C are cross-sectional views illustrating a method of manufacturing a memory card in accordance with a third example embodiment of the present invention. Here, the same reference numerals refer to the same elements of the above-mentioned memory card 100.

Referring to FIG. 13A, the PCB 10 is prepared. Here, the contact pad 16 is formed on a first face of the PCB 10. The converting member 18 is formed on the PCB 10. When the PCB 10 is bent into the box shape, the contact pad 16 is positioned on a second face of the box-shaped PCB 10 opposite to the first face.

Referring to FIG. 13B, a package member 50 is placed on the second face of the PCB 10. The converting member 18 is electrically connected to the control chip 12. Here, the control chip 12, the memory chip 14 and the wire 20 are molded in the package member 50. That is, after preparing the PCB 10, the package member 50 is located on the PCB 10.

Referring to FIG. 13C, the PCB 10 is bent into the box shape, thereby completing the memory card 100. In this example embodiment, the memory card 100 is manufactured using the package member 50.

According to the present invention, since functions of a control chip and an interface function of a contact pad in a memory card may be properly converted or selected, the memory card may be readily compatible with different digital devices such as computers, cellular phones, etc.

Moreover, because a converting member may be accessed from outside a box-shaped PCB, the control chip and interface functions of the memory card may be programmed after manufacturing processes are otherwise complete. Accordingly, as memory cards are completed, the memory cards may be programmed for a desired application. For example, as memory cards come off a manufacturing line, some may be programmed to operate with digital cameras, others may be programmed to operate with MP3 players, and still other memory cards may be programmed to operate with other types of electronic devices.

In other embodiments according to the invention, the memory cards may be reconfigured in-circuit or while otherwise installed in a device. For example, in some consumer devices that may support multiple functions (such as a camera that can play MP3s), the memory card function may be changed from a first function that supports MP3s to a second function that supports digital camera operations.

Having described embodiments of the present invention, it is noted that modifications and variations can be made by persons skilled in the art in light of the above teachings. It is therefore to be understood that changes may be made in the particular embodiment of the present invention disclosed which is within the scope and the spirit of the invention outlined by the appended claims.

What is claimed:

1. A memory card comprising:
a box-shaped printed circuit board (PCB) defining at least a partially enclosed interior space;
a control chip in the interior space defined by the box-shaped PCB, wherein the control chip is selectively configured according one or more application functions;
a memory chip, in the interior space, electrically coupled to the control chip and configured to store data;
a contact pad formed on the box-shaped PCB outside the interior space, the contact pad being electrically coupled to the control chip;
a converting member located outside the interior space defined by the box-shaped PCB and electrically coupled to the control chip, the converting member configured to provide an indication to the control chip to change the application function of the control chip and an interface function of the contact pad based on input external to the memory card; and
a multi-interface member located completely inside the interior space of the PCB and electrically coupled to the control chip and the converting member and configured to change the application function of the control chip and the interface function of the contact pad based on operations of the converting member.

2. The memory card of claim 1, wherein the control chip comprises a single control chip, and the functions of the single control chip are converted to be suitable for the different digital devices responsive to operations of the converting member.

3. The memory card of claim 1, wherein the control chip comprises at least two control chips having respective different functions adapted for different digital devices selected responsive to operations of the converting member.

4. The memory card of claim 1, wherein the memory chip comprises at least two memory chips.

5. The memory card of claim 1, further comprising:
a molding member in the interior space configured to support the control chip and the memory chip.

6. The memory card of claim 1, wherein the converting member comprises a switch, a circuit, a fuse, and/or a jumper.

7. The memory card of claim 1, wherein the multi-interface member comprises a circuit configured to re-define input/outputs between the contact pad and the control chip to provide the application function selected by the converting member.

8. The memory card of claim 7, wherein the circuit re-defines the inputs/outputs according to a first application function so that the control chip provides the first application function and re-defines the inputs/outputs according to a second application function so that the control chip provides the second application function without structural modification of the control chip.

9. A memory card comprising:
a box-shaped PCB defining at least a partially enclosed interior space;
a converting member located outside the interior space defined by the box-shaped PCB and electrically coupled to a control chip in the interior space, the converting member configured to provide an indication to the control chip to change an application function of the control chip and an interface function of the memory card based on input external to the memory card; and
a multi-interface member located completely inside the interior space of the PCB and electrically coupled to the control chip and the converting member to change the application function of the control chip and the interface function of the contact pad based on operations of the converting member.

10. The memory card of claim 9, wherein the converting member comprises a switch, a circuit, a fuse, and/or a jumper.

11. The memory card of claim 9, wherein the multi-interface member comprises a circuit configured to re-define input/outputs between the contact pad and the control chip to provide the application function selected by the converting member.

12. The memory card of claim 11, wherein the circuit re-defines the inputs/outputs according to a first application function so that the control chip provides the first application function and re-defines the inputs/outputs according to a second application function so that the control chip provides the second application function without structural modification of the control chip.

13. A memory card comprising:
a circuit configured to provide a first mode of operation and structure applicable to a first consumer digital device and configured to provide a second mode operation and structure applicable to a second consumer digital device.

14. The memory card of claim 13, further comprising third to n-th modes suitable for third digital device through n-th digital device, respectively,
wherein n is a natural number of no less than four.

15. The memory card of claim 13, wherein the first digital device and the second digital device are different from each other.

16. A consumer digital device comprising:
a receiving member for receiving a memory card configured to operate in a first mode or a second mode; and
an identifying member in the consumer digital device configured to communicate which of the first or second mode is supported by the consumer digital device.
